(19) United States
(12) Patent Application Publication
(10) Pub. No.: US 2005/0013719 A1
(43) Pub. Date: Jan. 20, 2005

(54) Alernative-step appliance rotary piston engine

(76) Inventors: Chun Hing Fong, Hong Kong (HK); Lu De Chang, Hong Kong (HK)

Correspondence Address: Chun Hing Fong;Rm 2202, 22/F, Block F, 560 King's Road, Hong Kong, HK

(21) Appl. No.: 10/607,379

(22) Filed: Jun. 26, 2003

(51) Int. Cl. F03C 2/00

(52) U.S. Cl. 418/36

(57) ABSTRACT

This rotary piston engine is to propel twin or double twin pistons to do a rotational run in the round-section cylinder. The characteristic is when the stop-piston is locked, it cannot rotate until being unlocked. Another piece or pairs rotary pistons perform the four processes of the internal combustion engine. They are air absorption, compression, expansion and exhaustion.

Alternative-step appliance (ASA) rotary piston engine can control twin or double twin pistons to perform stop and rotation alternatively in the cylindrical or frustum shape cylinder block. The characteristic is when the stop-piston is locked, it cannot rotate until being unlocked

Operation Theory

The purpose of ASA is that using two coaxial half rounded gears control two gears with lock head to rotate and stop in turn during its continuously rotation. Following is the instruction of composition and operation principle of ASA.

The composition of ASA is shown in FIG. 1. In the figure, 1 and 2 are the half-round gears which are positioned 180° facing to each other and they are coaxial. They can be made by the same steel mold. 3 and 4 are the special gears which are corresponding with the gears 1 and 2. They are at the concentrical axis and can be made in same bearing but different shaft sleeve. The boss is lock head. The edge of lock head is an arc which can coincide the smooth side of gears 1 and 2, by 1 to 3, 2 to 4.

For easily understood, put down the ASS′Y of FIG. 1, move gear 1 and 3 to the left, then it becomes FIG. 2-1 and FIG. 2-2. In these two figures, when gears 1 and 2 rotate counter-clockwise, the lock head of gear 3 will be locked by the smooth side of the gear 1 and then stop. At the same time, gear 4 can be rotated clockwise by gear 2.

When counter-clockwise rotation of gears 1 and 2 continue to FIG. 3-1 and FIG. 3-2, the lock head of gear 3 is just at the end of the smooth side of gear 1. At the same time, the lock head of gear 4 will get into the smooth side of the gear 2.

When gears 1 and 2 rotate to the position as FIG. 4-1 and FIG. 4-2. The lock head of gear 3 is pushed out of the smooth side of gear 1 and be unlocked. Therefore, gear 3 can be rotated clockwise by gear 1, while the lock head of gear 4 rotate into the smooth side of gear 2 and be locked.

It shows clearly that if gear 1 and gear 2 run one cycle, so do gear 3 and gear 4. Therefore, ‘one cycle ASA’ is called. If single-beetle piston (see FIG. 5-1 and FIG. 5-2) is fixed to gear 3 and 4 separately, then to be assembled into cylinder block (see FIG. 6), it forms the structure of pump machine, compressor or engine (see FIG. 7).

The piston in the FIG. 7 is locked when it is facing straight downward, i.e. the piston is locked straight downward in turn. Therefore, the hole 5 and hole 6 are separated. The function of another piston during rotation is for the air absorption and air drainage. It is the operation principle of the pump and compressor.

Piston of FIG. 7 is controlled by the rotary engine of FIG. 1. The gear 1 and gear 2 s' pivot will output the motivation and inertial flywheels are fixing on the outputting pivots. When the high-pressure air is pushed into the spiracle 5, the pistons will be rotated in turn clockwise. Then, gear 3 and gear 4, which are coaxial with the piston, will rotate the gear 1 and 2 counter-clockwise. It is the operation principle of the external combustion engine.

In case of the gear 3 and gear 4 are refitted into the gear 9 and gear 10 owning two lock-heads separately (see FIG. 8-1 and FIG. 8-2). If the gear 7 and gear 8, which are fixing on the same pivot, run one cycle, the gear 9 and 10 will run half cycle. It is called a ‘half cycle’ ASA (see FIG. 9).

If fixing the twin-beetle piston (see FIG. 10-1 and FIG. 10-2) to gear 9 and gear 10 separately, then to be assembled into double-twin spiracle cylinder block (see FIG. 11), it forms the twin-entry and twin-egression pump machine, compressor or external combustion engine, especially the Stirring engine.

If fixing the gear 9 and gear 10 of half-cycle rotary engine to the twin-beetle piston (in FIG. 10-1 and FIG. 10-2), then to be assembled into the cylinder block (see FIG. 12), it forms an internal-burning machine (see FIG. 13). Reference the FIG. 13, 11 is the intake hole. 12 is the exhausting hole and 13 is spark plug (or fuel oil nozzle). The cylinder is divided into four rooms by twin-double piston. They are room I-II, room II-III, room III-IV and room I-IV.

FIG. 14-1 and FIG. 14-2 are the corresponding pictures between four gears of ‘half ASA’ and gears in FIG. 13, That is to say: gear 31 and piston I-III have the same shaft. Gear 32 and piston II-IV have the same shaft. Gear 21 and gear 22 are assembled onto the outputting shaft which have the inertia flywheels. According to the relative relationship of FIG. 13, FIG. 14-1 and FIG. 14-2, the operation process from the stage of ‘A’ to ‘H’ in the FIG. 15-a and FIG. 15-b are listed.

Suppose the gear 21 and gear 22 to rotate counter-clockwise in the FIG. 15-a and FIG. 15-b.

At the stage of ‘A’, the gaseous mixture in the I-II room is compressed completely. The lock head of gear 31 which coaxial to I-III is locked when rotating into the smooth side of gear 21. Meanwhile the gear 32 which coaxial to II-IV is released. By the driving of flywheel, the gear 21 and gear 22 will rotate clockwise continuously.

At the moment of turning to ‘B’ position. The lock head of gear 31 just rotate into the smooth side and then lock. At this moment, spark plug (13) ignites the compress gas in the I-II room. Due to the locked piston in room I-III, the compress air only let the piston II-IV rotated clockwise.

Under the high pressure, the piston II-IV rotates continuously to the stage ‘C’. During the stage ‘D’ to the stage ‘E’, the high-pressure air in the room I-II expands and the exhaust in the room II-III is continued to discharge. At the same time, the room III-IV absorbs the gaseous mixture and room I-IV compresses the air continuously.

At the moment of ‘E’, high-pressure air in room I-II finished the work and room II-III finished discharging. The room III-IV finished absorbing gaseous mixture and room I-IV finished compressing the gaseous mixture. At this moment, this is just similar of the stage ‘A’.

Continuously, the state of ‘F’ is similar to ‘B’. The state of ‘G’ is similar to ‘C’ and the state of ‘H’ is similar to ‘D’. That is to say, at the moment of ‘H’, it has had two times of ignition. It means that there are two times of ignition in the cylinder when the output pivot runs one cycle.

FIG. 16 is the diagram of the ‘ASA’ and the piston. Piston I-III is coaxial with the gear 31 and piston II-IV is coaxial with the gear 32.

Compression ratio is depended on the preserving space when the two pistons touched together. The space sample can reference the FIG. 10-1 and FIG. 10-2, FIG. 17-1 and FIG. 17-2, or FIG. 18-1 and FIG. 18-2.

According to the ‘ASA’ specific condition, the double-twin gears can be placed on one side or both sides of the cylinder. If considering forming the piston and its coaxial gears as one unit, the single-beetle piston can be made, referencing the side elevation of FIG. 19-1 and FIG. 19-2 (FIG. 19-1 and FIG. 19-2 are the same but shown in different angles). On the other hand, if they are mounted face-to-face onto the free-pivot of FIG. 20 and then placed in the cylinder. Then, the double-twin gears of ASA will be laid on both sides of the cylinder.

Double-beetle piston can be made referencing to the side elevation of FIG. 21-1 and FIG. 21-2. If they are mounted face-to-face onto the free-pivot of FIG. 22, it forms the FIG. 23-2 (The FIG. 23-1 and FIG. 23-3 are the look-down elevation and look-up elevation figures of FIG. 23-2 respectively). If they are put into cylinder, the double-twin gears of ASA will be laid on both sides of the cylinder.

FIG. 24 is the lookdown elevation of FIG. 23-2 which to be cut off along with the dashed line KL. It is clear that piston and free-shaft are closely tight.

FIG. 25 shows the twin-gears couple of ASA with the corresponding half gears that are laid at the both sides of cylinder. (Note: in FIG. 25, shadow line represent the vertical cross section of the cylinder and its cover).

The advantage of forming the piston and gear into one unit (FIG. 19-1 and FIG. 21-1) is that they can be molded by one set of tool by providing the proper materials. So, it is more efficiently.

The slider and piston of the ASA should consider the following conditions. In no case the central angle covered by the piston width should be larger than the central angle covered by the slider. Also, regarding internal combustion engine, the central angle covered by piston width should be equal to the central angle covered by the slider.

Guideline of Making the ASA Gear
1. Half-round gear:
   For the gear which has 2n teeth, the semicircle arc is made by withdrawing n teeth, and then the half-round gear is made.
2. Gear with one lock head:
   Let the gear has (n+m−1) teeth. The lock head can be made by using m teeth, including the teeth tips of the two teeth sides. The remaining is (n−1) teeth.
3. Gear with two lock heads:
   Let the gear has 2 (n+m−1) teeth. Dividing into two groups and each group has (n+m−1) teeth. According to the above method, making two lock heads with m teeth (include the teeth tips of the two sides of the teeth) and the two side of the gear has (n−1) teeth.
4. As the m mentioned above, regularly 3 to 5 teeth are chosen. If the size of teeth is small, it needs more.
5. The central angle covered by the slider is suggested between 30° to 40°.

FIG. 26 is the single-beetle-piston internal combustion engine which is made by a ‘one cycle ASA’. The characteristic is that the volume expansion ratio is larger than that of the compression. For example, if the compression ratio is 9.5:1, the expansion volume will be increased to 20 times or more. Almost all the expansion energy due to the high pressure is used.

Referring to the FIG. 26, 15 and 16 are the valves for controlling the air absorption. The operation of the two valves is in the same phase. 17 is the valve for the draining air. 18 is the spark plug or fuel oil nozzle.

Cylinder is divided into two areas by two pistons. If using the straight downward locked piston as the dividing line, the area at the left hand side is the front room while that of right hand side is back room.

The operation procedure of the valves in the piston is shown in table 1.

TABLE 1
The operation procedure of the valves in the piston

| | Absorbing | | | Draining |
|---|---|---|---|---|
| | valve | Front room | Back room | valve |
| 27-1, 27-2 | Open | Absorb fuel gas | Draining exhaust | Open |
| 27-3, 27-4 | Open | Absorbing air | Compressed fuel | Close |
| | | | gas | |
| 27-5, 27-6 | Close | Ignite expand | Draining air | Open |
| | | and explode | | |
| 27-7, 27-8 | Open | Absorb fuel gas | Draining exhaust | Open |
| 27-9, 27-10 | Open | Absorbing air | Compressed fuel | Close |
| | | | gas | |
| 27-11, 27-12 | close | Ignite to | Draining air | Open |
| | | expand and | | |
| | | explode | | |

Note:
‘absorbing air’ means the air without any fuel
‘absorbing fuel gas’ means the air with fuel.

According to the table above, the four operating procedures of internal combustion engine are absorbing fuel gas, fuel gas compression, igniting the fuel gas to explode and draining the exhaust. While absorbing fuel gas and draining exhaust perform at the same time, it may be said that altogether there are three processes. So, three cylinders can be used the same output shaft. The operation procedures of the three cylinders are shown in the table 2.

TABLE 2
The operation procedures of the three cylinders

| First cylinder | | Second cylinder | | Third cylinder | |
|---|---|---|---|---|---|
| Front | Back | Front | Back | Front | Back |
| room | room | room | room | room | room |
| Absorbing | Draining | Absorbing | Compress | Lighten to | Draining |
| fuel gas | exhaust | air | fuel gas | explode | air |
| Absorbing | Compress | Lighten to | Draining | Absorbing | Draining |
| air | fuel gas | explode | air | fuel gas | air |
| Lighten to | Draining | Absorbing | Draining | Absorbing | Compress |
| explode | air | fuel air | exhaust | air | fuel gas |

According to the table 2, among the three processes, ignite expanding to explode is occurred at one of the cylinder. It means that there is an explosion to occur for each rotation of the output shaft.

These three cylinders may not need three sets (total 12 gears) of ASA. Two sets of ASA (total 8 gears) or three pairs (6 gears) of ASA can be used.

It is the same as the double-beetle piston. Inertial flywheels must be fixing on the outputting pivots in order to prevent the reversible rotation. Also, it provides the fair output.

The boss gear of the output shaft can control the valve open or close. FIG. 28 is the valve operation diagram. In the figure, the gear 28 is fixed coaxial on the output shaft. Gear 27 joins coaxial with the boss gear 25 and 26. Then put it on the shaft of the piston and joined concentrically.

For the above internal combustion engines, no matter with or without valves, the controlling air-intake valve is need to fix at the spiracle in order to control the amount of the air intake.

The above piston beetles of pump, compressor engine or internal combustion engine are better used the hollow or honey-comb center type in order to reduce the mass.

### FIGURE ILLUSTRATION

FIG. 1: The composition diagram of the ASA

FIG. 2-1, FIG. 2-2, FIG. 3-1, FIG. 3-2, FIG. 4-1, FIG. 4-2:

The decomposed diagrams of the ASA in the different rotational angles.

FIG. 5-1, FIG. 5-2:

The diagram of a single beetle piston

FIG. 6: The cross-section diagram of the cylinder block

FIG. 7: The cross-section diagram of the pair single-beetle piston in the cylinder block

FIG. 8-1, FIG. 8-2:

The decomposed diagram of the ‘half cycle ASA’

FIG. 9: The diagram of the ‘half cycle ASA’

FIG. 10-1, FIG. 10-2:

The diagram of the double-beetle piston

FIG. 11: The cross-section diagram of the double-beetle piston in the cylinder block

FIG. 12: The cross-section diagram of the cylinder block of internal combustion engine. 13 is the spark plug (or fuel oil nozzle)

FIG. 13: The cross-section diagram of the pair double-beetle piston in the cylinder block of the internal combustion engine

FIG. 14-1, FIG. 14-2:

The decomposed diagram of the two pair gears of the ‘half ASA’.

The position of the gears is corresponding to the FIG. 13. Dash line is represented the same connection system.

FIG. 15-a, FIG. 15-b:

Under the control of the ASA, the two pairs piston in the cylinder block need to met the requirement of the internal combustion engine when performing a rotation.

FIG. 16: The diagram of the twin-double piston installing the ‘half ASA’

FIG. 17-1, FIG. 17-2, FIG. 18-1, FIG. 18-2:

The diagrams of the double-beetle piston which show that different shape can be used.

FIG. 19-1, FIG. 19-2, FIG. 20, FIG. 21-1, FIG. 21-2, FIG. 22:

The diagrams indicate that the gears and pistons of ASA can be molded by one set of tool, and free-pivot

FIG. 23-1, FIG. 23-2, FIG. 23-3:

FIG. 23-1, FIG. 23-2 and FIG. 23-3 are the look-down elevation, side elevation and look-up elevation diagrams respectively of the FIG. 21-1 and FIG. 21-2 which are mounted face-to-face onto the free-pivot of the cylinder (shown on the FIG. 22).

FIG. 24: The sectional diagram of FIG. 23-2 which to be cut off along with the dashed line KL

FIG. 25: The half-round gear of ASA is fixed to the gear of FIG. 23-2 to control the movement of the piston

FIG. 26: The cross-section diagram of the internal combustion engine which is formed by the single-beetle piston

FIG. 27: The cross-section diagram of the internal combustion engine of the single-beetle piston, indicating the operation of the valves in the piston at different period of time

FIG. 28: The diagram of the gear and the convex gear of the spiracle valve in the single-beetle piston of the internal combustion engine. Gear 28 is in concentrical axis with outputting shaft. Gear 27 is concentrically with gear 25 and 26, and are coaxial with the piston.

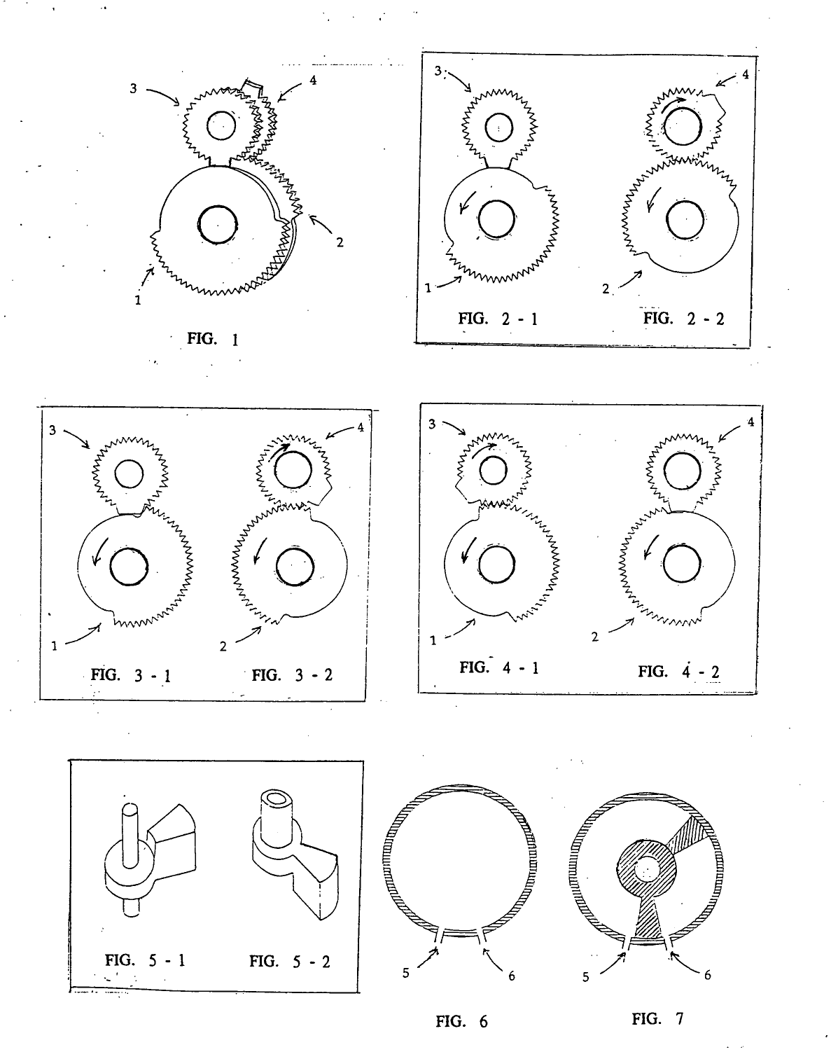

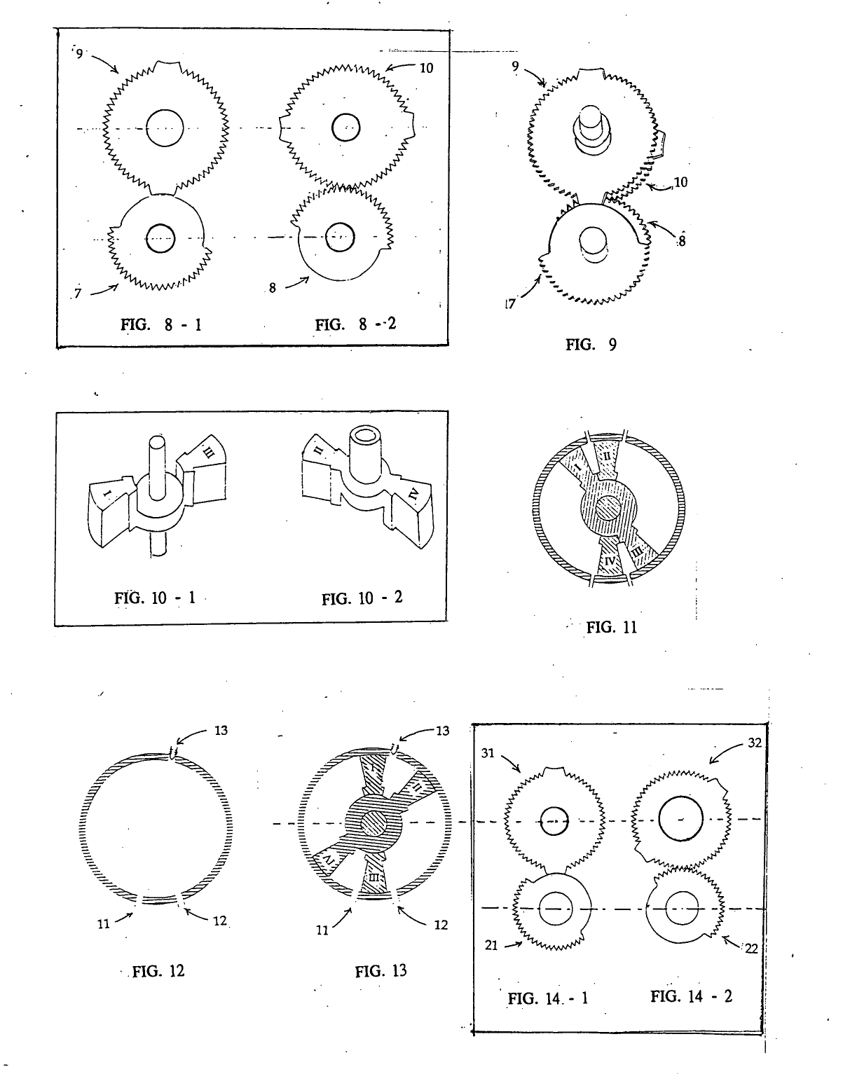

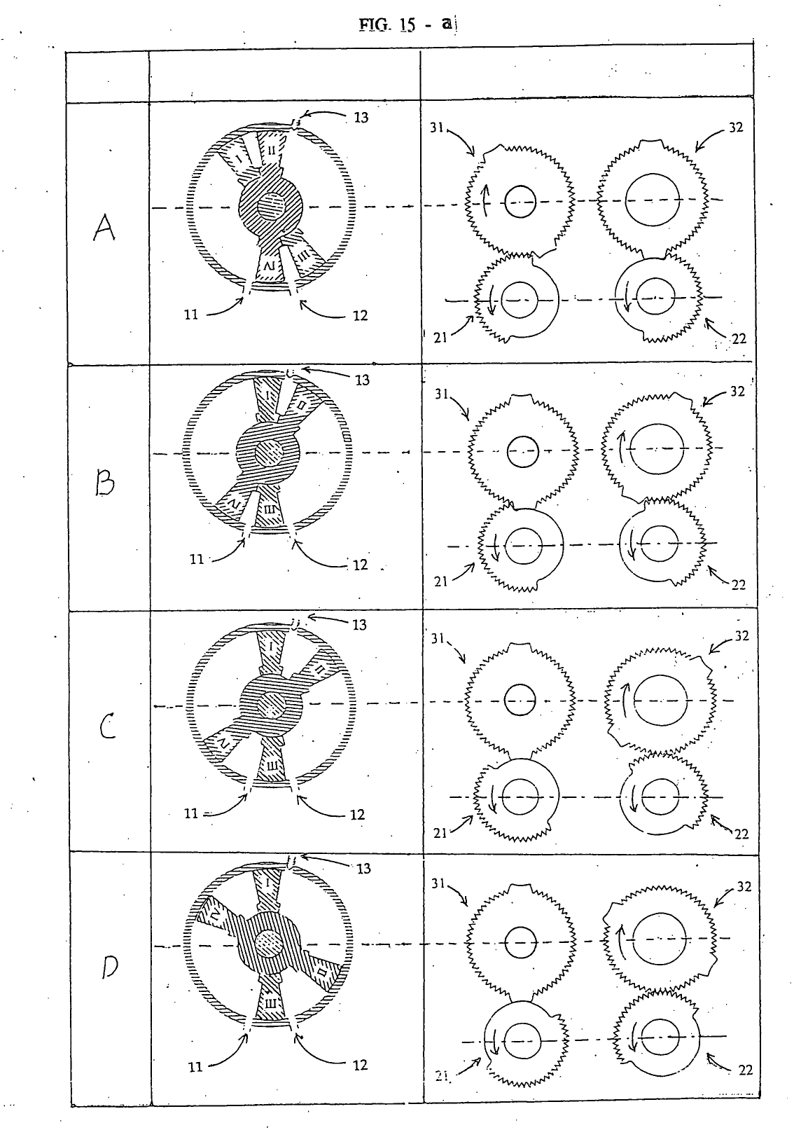

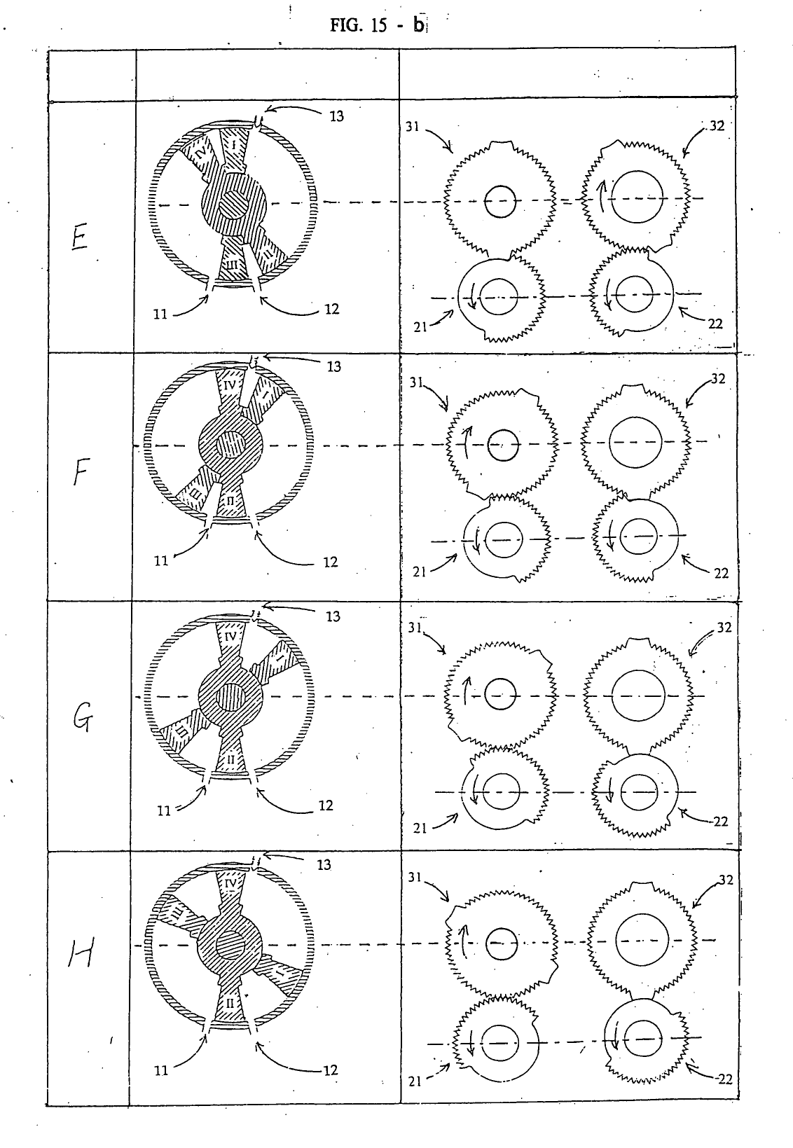

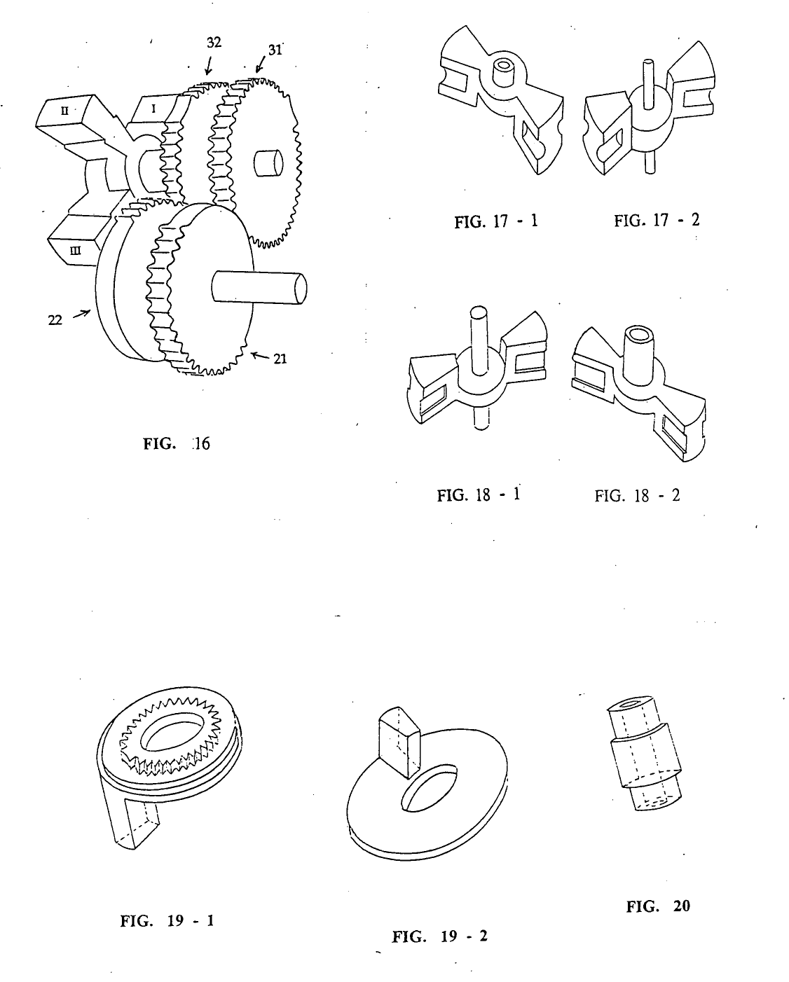

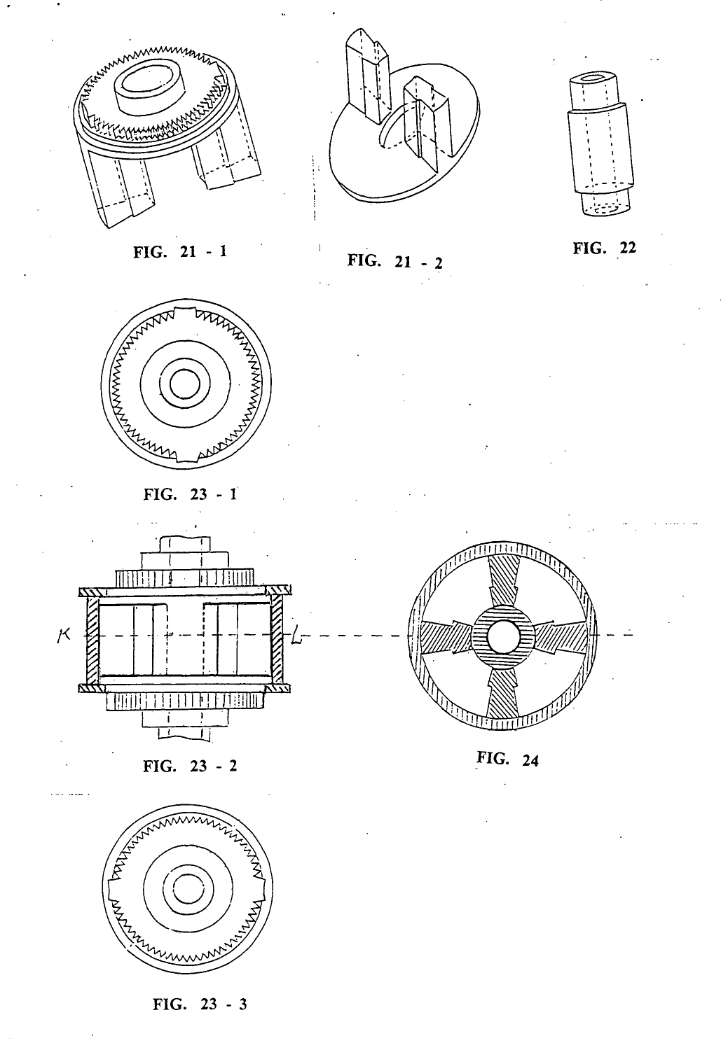

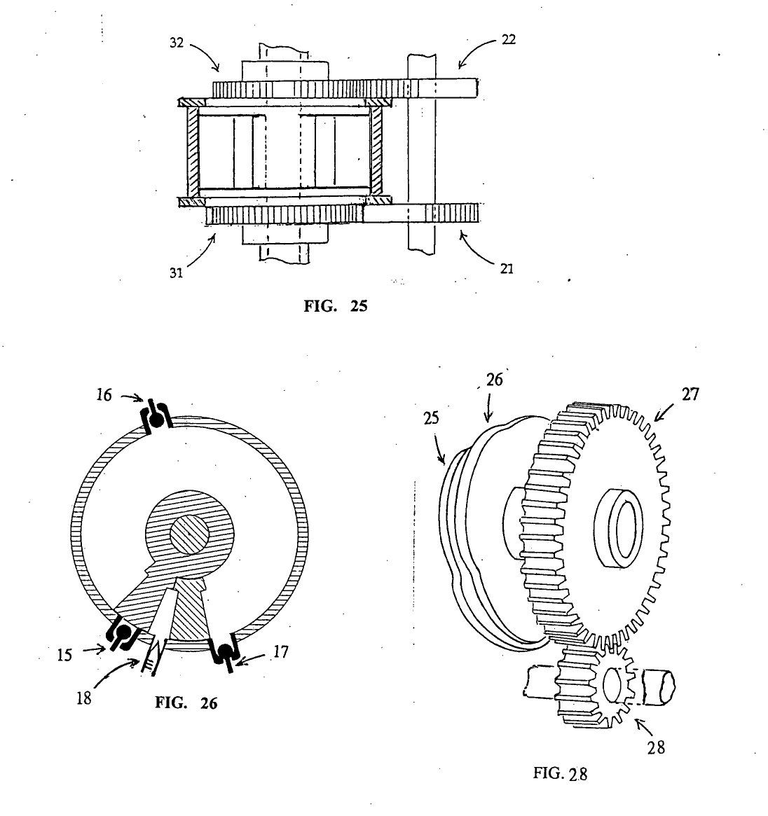

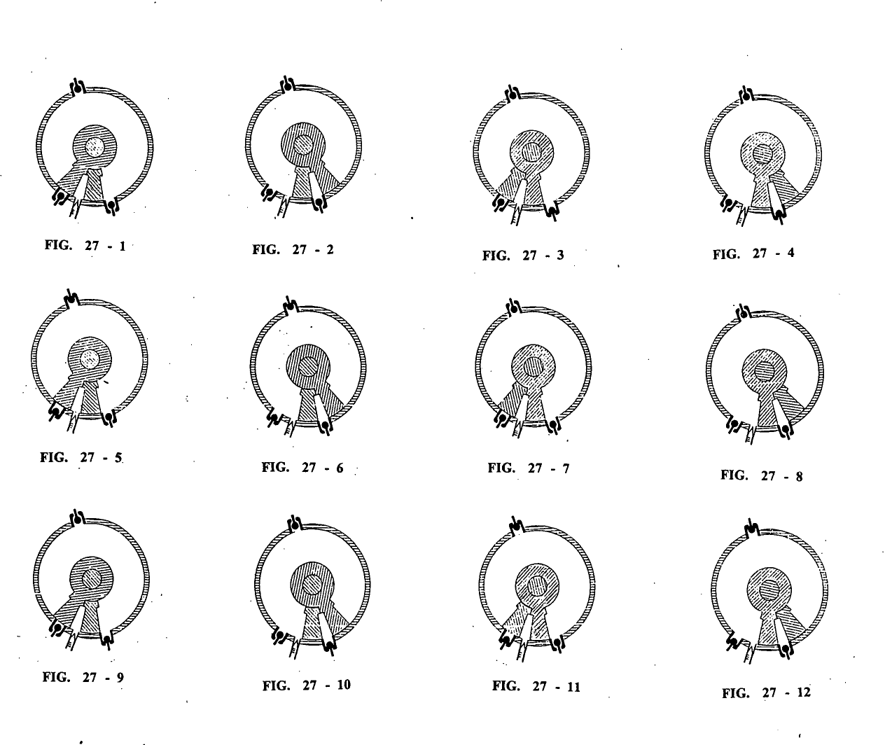

The gears of ASA which is coaxial with the piston can be made by one steel mold (FIG. 9-1 and FIG. 21-1).

2. Referring to the claim no.1, the characteristic of ASA is that either using ‘one cycle ASA’ to operate twin piston or using ‘half cycle ASA’ to operate double twin pistons can form be the engine or pump engine.

3. Referring to the claim no.1, the characteristic of ASA is the double twin gears couple which is used to operate pistons to do a rotational run can be installed at one side or both sides of cylinder.

4. Referring to the claim no.1, the characteristic of ASA is the gear together with the piston, which is coaxial with the gears, can be made by one steel mold 5. Referring to the claim no.1, the characteristic of ASA is the two coaxial half rounded gears, which are positioned at 180° facing to each other, matched with two corresponding gears with one or two lock heads at the concentrical axis to form a ‘one cycle ASA’ or ‘half cycle ASA’.

1. The design of Alternative-step Appliance Rotary Piston Engine is depended on the operation of twin or double twin pistons to do a rotational run in the round-section cylinder. The characteristic is when the stop-piston is locked, it cannot rotate until being unlocked.
The purpose of ASA is that using two coaxial half rounded gear, which are positioned at 180° facing to each other, to control the corresponding two gears with lock head at the concentrical axis. The two gears, each with a lock head, to form ‘one cycle ASA’ (FIG. 1). On the other hand, the gears, each with two lock heads, can form a ‘half-cycle ASA’ (FIG. 9).
One cycle ASA operates twin pistons in the cylinder which has the intaking and draining holes to form a pump machine or external combustion engine.
One cycle ASA operates twin pistons to be assembled in the spiracles with valve and in the cylinder with the spark plug or fuel oil nozzle. Then, the internal combustion engine is formed.
Half cycle ASA operates two pairs of pistons to be assembled into double-twin spiracle cylinder block to form the twin-entry and twin-egression external combustion engine or pump machine (FIG. 11).
Half cycle ASA operates two pairs of pistons to be assembled into twin spiracle cylinders in which no spark plug and fuel oil nozzle. It is the principle of the internal combustion engine (FIG. 13).
ASA twin gears couple can be installed at one side or both sides of cylinder (FIG. 24).
The gears of ASA which is coaxial with the piston can be made by one steel mold (FIG. 19-1 and FIG. 21-1).

2. Referring to the claim no.1, the characteristic of ASA is that either using ‘one cycle ASA’ to operate twin piston or using ‘half cycle ASA’ to operate double twin pistons can form be the engine or pump engine.

3. Referring to the claim no.1, the characteristic of ASA is the double twin gears couple which is used to operate pistons to do a rotational run can be installed at one side or both sides of cylinder.

4. Referring to the claim no.1, the characteristic of ASA is the gear together with the piston, which is coaxial with the gears, can be made by one steel mold

5. Referring to the claim no.1, the characteristic of ASA is the two coaxial half rounded gears, which are positioned at 180° facing to each other, matched with two corresponding gears with one or two lock heads at the concentrical axis to form a ‘one cycle ASA’ or ‘half cycle ASA’.
